(19) United States
(12) Patent Application Publication
(10) Pub. No.: US 2025/0266937 A1
(43) Pub. Date: Aug. 21, 2025

(54) APPARATUS IN WIRELESS COMMUNICATION SYSTEM AND METHOD PERFORMED BY THE SAME

(71) Applicant: Samsung Electronics Co., Ltd., Gyeonggi-do (KR)

(72) Inventors: Sa ZHANG, Beijing (CN); Feifei SUN, Beijing (CN)

(21) Appl. No.: 18/858,523

(22) PCT Filed: Apr. 19, 2023
(86) PCT No.: PCT/KR2023/005297

§ 371 Date: Oct. 21, 2024

(30) Foreign Application Priority Data
Apr. 22, 2022 (CN) 202210432313.9
Apr. 4, 2023 (CN) 202310356317.8

(51) Int. Cl. H04L 1/1829; H04L 1/1812; H04W 72/21

(52) U.S. Cl. CPC H04L 1/1864; H04L 1/1812; H04W 72/21

(57) ABSTRACT

The disclosure relates to a 5G or 6G communication system for supporting a higher data transmission rate. An apparatus in a wireless communication system and a method performed by the same are provided. The method includes: determining time domain overlapping among a first physical uplink control channel (PUCCH) associated with a second hybrid automatic repeat request-acknowledgement (HARQ-ACK) feedback mode and a second PUCCH or a physical uplink shared channel (PUSCH); and resolving the time domain overlapping among the first PUCCH and the second PUCCH or the PUSCH. The invention can improve the communication efficiency.

### TECHNICAL FIELD

The disclosure generally relates to the field of wireless communication, and in particular, to an apparatus in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), fulldimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The purpose of this application is to be able to solve at least one of the drawbacks of the prior art.

There is a need to resolve a time domain overlapping problem among several PUCCHs or PUSCH.

### Solution to Problem

According to at least one embodiment of the disclosure, a method performed by a terminal in a wireless communication system is provided. The method includes: determining time domain overlapping among a first physical uplink control channel (PUCCH) associated with a second hybrid automatic repeat request-acknowledgement (HARQ-ACK) feedback mode and a second PUCCH or a physical uplink shared channel (PUSCH); and resolving the time domain overlapping among the first PUCCH and the second PUCCH or the PUSCH.

According to at least one embodiment of the disclosure, a method performed by a terminal in a wireless communication system is provided. The method includes: receiving first configuration information on a semi-persistent scheduling (SPS) physical downlink shared channel (PDSCH) through higher layer signaling, where the first configuration information includes a parameter indicating a transmission of the SPS PDSCH with repetitions; receiving downlink control information (DCI) through a downlink control channel (PDCCH), where the DCI is scrambled by a multicast radio network temporary identifier (RNTI) and schedules a point-to-multipoint (PTM)-based retransmission of the SPS PDSCH; and determining a number of repetitions of the PTM-based retransmission of the SPS PDSCH.

According to some embodiments of the disclosure, a terminal in a wireless communication system is also provided. The terminal includes a transceiver configured to transmit and receive signals; and a controller coupled to the transceiver and configured to perform one or more of operations in the above-described methods performed by the terminal.

According to some embodiments of the disclosure, a computer-readable storage medium having one or more computer programs stored thereon is also provided, wherein the one or more computer programs, when executed by one or more processors, can implement any of the above-described methods.

### Advantageous Effects of Invention

Embodiments of the present disclosure provides methods and apparatus for determining time domain overlapping among several PUCCHs and resolving the time domain overlapping among the several PUCCHs or PUSCH.

Therefore, communication efficiency can be improved.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to some embodiments of the disclosure;

FIGS. 2A and 2B illustrate example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a second transceiving node according to some embodiments of the disclosure;

FIG. 5 illustrates a flowchart of a method performed by a UE according to some embodiments of the disclosure;

FIGS. 6A-6C illustrate some examples of uplink transmission timing according to some embodiments of the disclosure;

FIG. 7 illustrates an example of bandwidth part (BWP) switching according to some embodiments of the disclosure;

FIGS. 8A and 8B illustrate examples of time domain resource allocation tables according to some embodiments of the disclosure;

FIG. 9 illustrates a schematic diagram of uplink transmission overlapping according to some embodiments of the disclosure;

FIG. 10 illustrates a flowchart of a method performed by a terminal according to some embodiments of the disclosure;

FIG. 11 illustrates a flowchart of a method performed by a terminal according to some embodiments of the disclosure;

FIG. 12 illustrates a block diagram of a first transceiving node according to some embodiments of the disclosure; and

FIG. 13 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

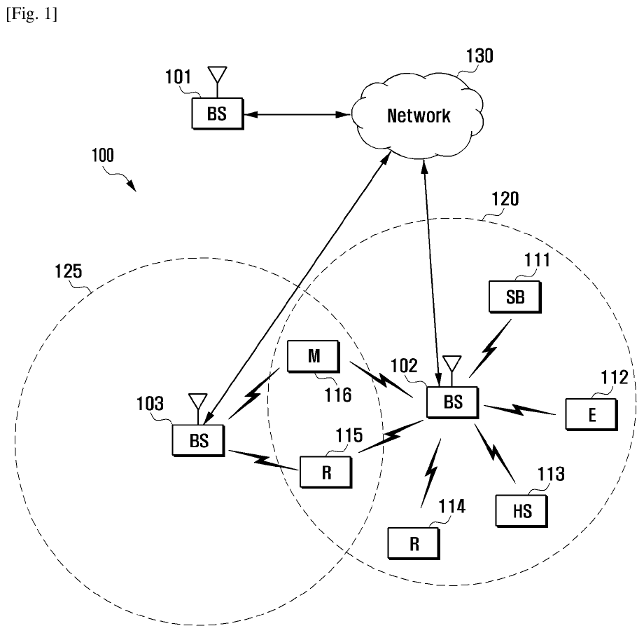

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

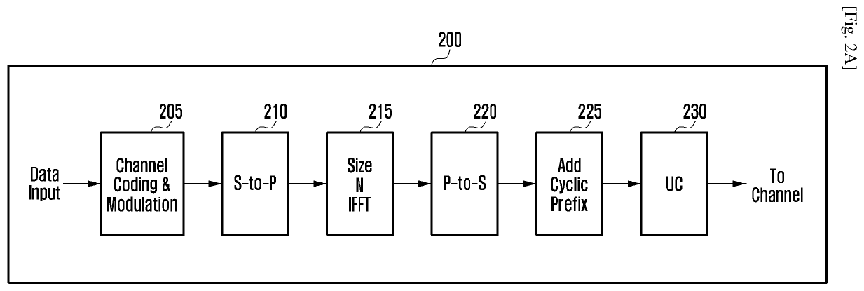

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

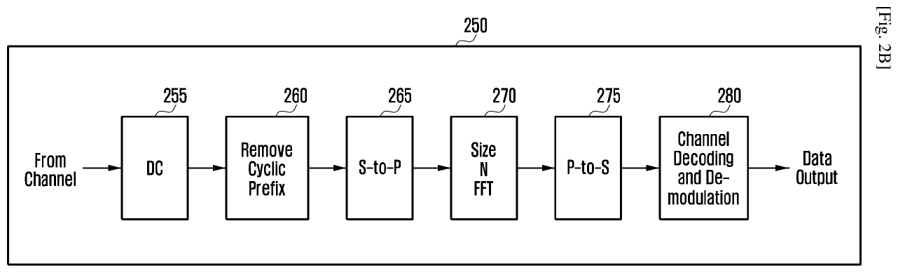

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with singleline displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a settop box and other devices.

With the rapid development of information industry, especially the increasing demand from mobile Internet and internet of things (IoT), it brings unprecedented challenges to the future mobile communication technology. According to the report of International Telecommunication Union (ITU) ITU-R M. [IMT.BEYOND 2020.TRAFFIC], it can be predicted that by 2020, compared with 2010 (4G cra), the growth of mobile traffic will be nearly 1000 times, and the number of UE connections will also exceed 17 billion, and the number of connected devices will be even more alarming, with the massive IoT devices gradually infiltrating into the mobile communication network. In order to meet the unprecedented challenges, the communication industry and academia have carried out extensive research on the fifth generation (5G) mobile communication technology to face the 2020s. At present in ITU report ITU-R M. [IMT. VISION], the framework and overall goals of the future 5G has been discussed, in which the demand outlook, application scenarios and important performance indicators of 5G are described in detail. With respect to new requirements in 5G, ITU report ITU-R M. [IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, a HARQ-ACK feedback mode of Multicast Broadcast Services (MBS) may be NACK-only. If a PUCCH carrying HARQ-ACK information of NACK-only overlaps with a PUCCH or PUSCH carrying other UCI(s) in time domain, the HARQ-ACK information of NACK-only may be multiplexed or prioritized with other UCI(s) or uplink data. For example, the HARQ-ACK information and the other UCI(s) or uplink data may be multiplexed in a PUCCH or PUSCH. In order to reduce blind detection by a base station, a result of the multiplexing should not depend on HARQ-ACK information (decoding of a PDSCH); for example, it is assumed that the PUCCH carrying the HARQ-ACK information of NACK-only always exists, a UE may select different PUCCH resources due to different HARQ-ACK information states, and time domain positions of the PUCCH resources will affect the result of the multiplexing. How to determine the consistency of understanding of the multiplexing or prioritization result between the UE and the base station is a problem that needs to be solved.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

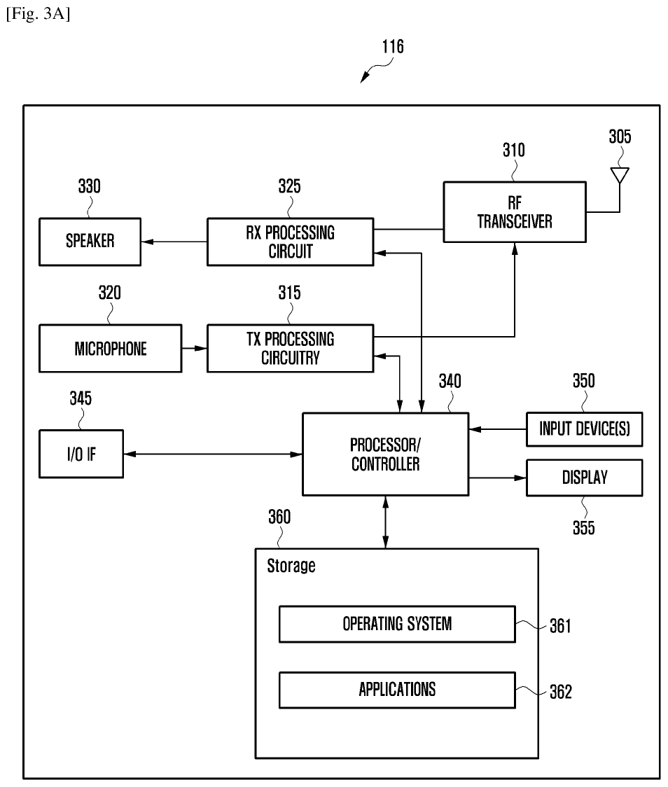

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in the embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

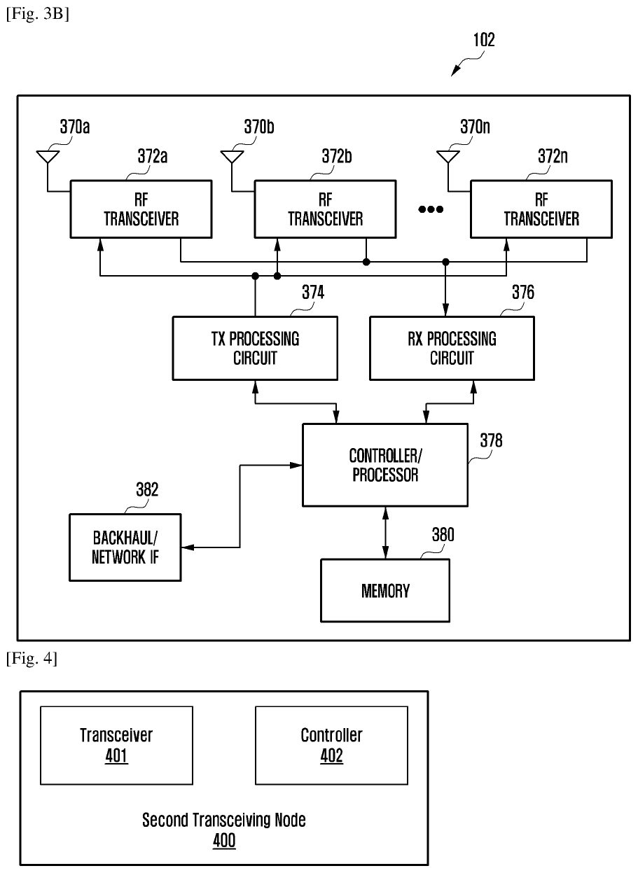

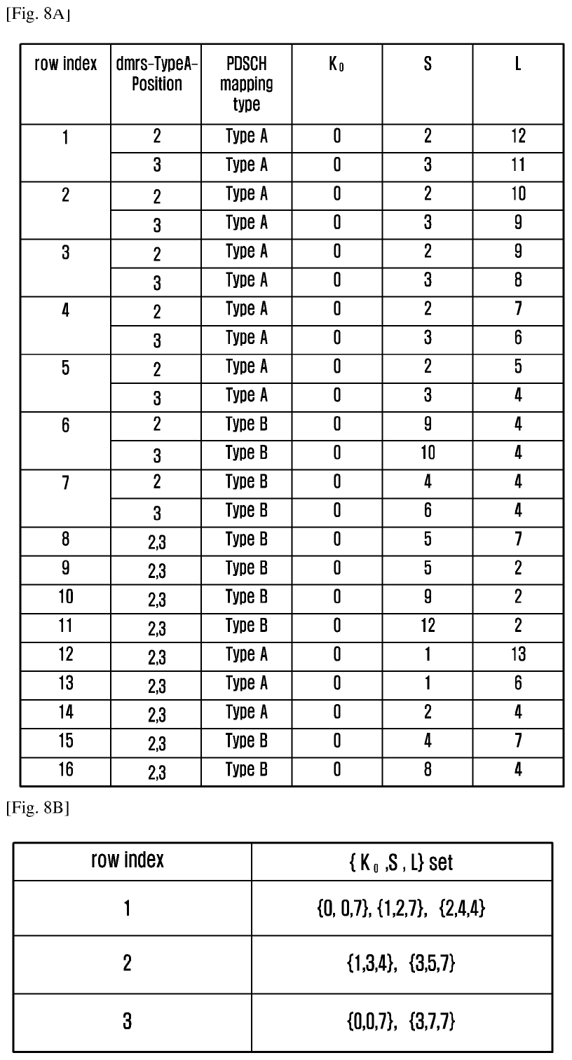

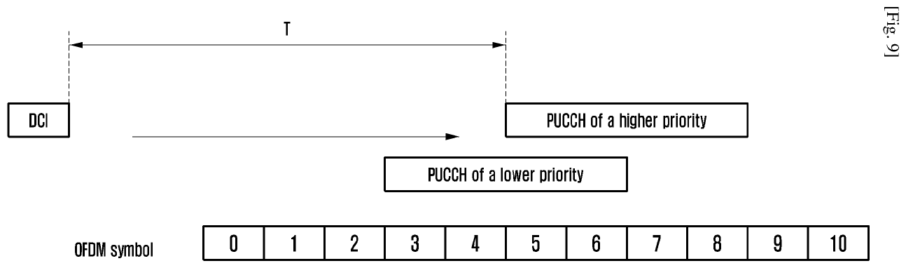

In some implementations, the controller 402 may be configured to perform one or more of operations in methods of various embodiments described below. For example, the controller 402 may be configured to perform one or more of operations in a method 500 to be described in connection with FIG. 5, a method 1000 to be described in connection with FIG. 10, and a method 1100 to be described in connection with FIG. 11 later.

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH carrying SR may be a PUCCH carrying positive SR and/or negative SR. The SR may be the positive SR and/or the negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the first time unit and the second time unit may be one or more slots, one or more subslots, one or more OFDM symbols, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration information (e.g. configuration parameters).

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

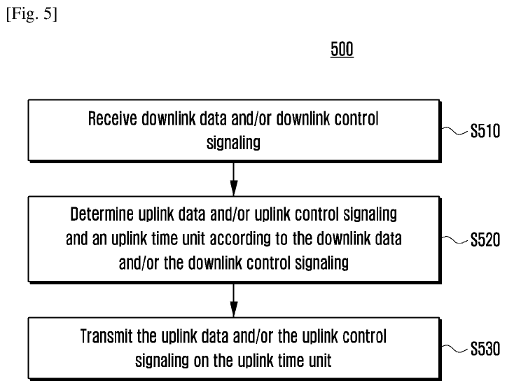

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH reception in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH reception and the PDSCH, and K1 may be in units of uplink time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K1, the timing parameter K0 may be used interchangeably with a timing parameter K0, and the timing parameter K2 may be used interchangeably with a timing parameter K2.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or subslots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

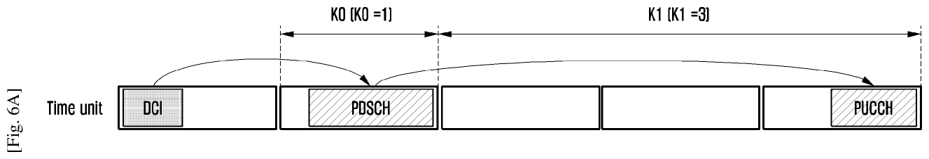

In NR, a bandwidth of the UE may be dynamically changed. The base station may configure multiple BWPs (Bandwidth Parts) for the UE through higher layer signaling. The base station may activate one of multiple BWPs. For example, the activated BWP may be an active BWP. The base station may also indicate a switching from a current active BWP to another BWP (which may be referred to as active BWP switching or change, or simply, BWP switching or change) through signaling (e.g., DCI). For example, the other BWP switched to becomes the active BWP. When the UE receives an indication of the BWP switching, the activated BWP is deactivated and the other BWP is activated. FIG. 7 illustrates an example of the BWP switching according to embodiments of the disclosure. As shown in FIG. 7, in a first time unit, the UE has a large traffic, and the system configures a large bandwidth (BWP1) for the UE; in a second time unit, the UE has a small traffic, and the system configures a small bandwidth (BWP2) for the UE to satisfy the basic communication requirements; and in a third time unit, the system finds that there is a wide range of frequency selective fading in the bandwidth where the BWP1 is located, or resources are relatively scarce in a frequency range where the BWP1 is located, so a new bandwidth (BWP3) is configured for the UE.

The UE only needs to adopt a center frequency point and sampling rate of a corresponding BWP. Moreover, each BWP is not only different in the frequency point and bandwidth, but also may correspond to different configurations. For example, a subcarrier spacing, a CP type, an SSB (Synchronization Signal and PBCH block) (including Primary Synchronization Signal (PSS), Secondary Synchronization Signal (SSS), and PBCH) period of each BWP may be configured differently to adapt to different services.

In some implementations, the UE may be configured with two levels of priorities for uplink transmission. For example, the UE may be configured to multiplex UCIs with different priorities via higher layer signaling (e.g., through the 3GPP parameter UCIMUXWithDifferentiatPriority); otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in cmbodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

In some examples, multiplexing of multiple uplink transmissions (e.g., a PUCCH and/or a PUSCH) overlapping in time domain may be multiplexing of UCI information in the PUCCH in a PUCCH or PUSCH.

In some examples, prioritizing of two uplink transmissions (e.g., a PUCCH and/or a PUSCH) overlapping in time domain by the UE may include that the UE transmits the uplink transmission (e.g., the PUCCH or the PUSCH) with the higher priority and does not transmit the uplink transmission (the PUCCH or the PUSCH) with the lower priority.

In some implementations, the UE may be configured with a subslot-based PUCCH transmission. For example, a subslot length parameter (which may also be referred to as a parameter with respect to a subslot length in embodiments of the disclosure) (e.g., the parameter subslotLengthForPUCCH in 3GPP) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of this PUCCH configuration parameter is one slot by default. If a subslot length parameter is configured in the PUCCH configuration parameter, the scheduling time unit of this PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the parameter subslotLengthForPUCCH in 3GPP), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating secondary cell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which may be referred to as Group RNTI (G-RNTI) in embodiments of the disclosure) for scrambling of a dynamically scheduled multicast transmission (e.g., PDSCH) or an RNTI (which may be referred to as group configured scheduling RNTI (G-CS-RNTI) in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same uplink time unit, the UE may generate the HARQ-ACK codebook based on a predefined rule. For example, if a PDSCH is successfully decoded, the HARQ-ACK information for this PDSCH reception is positive ACK. The positive ACK may be represented by 1 in the HARQ-ACK codebook, for example. If a PDSCH is not successfully decoded, the HARQ-ACK information for this PDSCH reception is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook in 3GPP) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception.

It should be noted that, in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain. In some implementations, if HARQ-ACK information transmitted in a same uplink time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same uplink time unit only includes HARQ-ACK information for one or more SPS PDSCH receptions, the UE may generate HARQ-ACK information according to a rule for generating a HARQ-ACK codebook for a SPS PDSCH.

In some implementations, if HARQ-ACK information transmitted in a same uplink time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook in 3GPP) or a dynamic HARQ-ACK codebook (e.g., Type-2 HARQ-ACK codebook in 3GPP) according to a PDSCH HARQ-ACK codebook configuration parameter (e.g., the parameter pdsch-HARQ-ACK-Codebook in 3GPP). The dynamic HARQ-ACK codebook may also be an enhanced dynamic HARQ-ACK codebook (e.g., Type-2 HARQ-ACK codebook based on grouping and HARQ-ACK retransmission in 3GPP).

In some implementations, if HARQ-ACK information transmitted in a same uplink time unit includes only HARQ-ACK information for a SPS PDSCH (e.g., a PDSCH not scheduled by a DCI format), the UE may generate the HARQ-ACK codebook according to a rule for generating a HARQ-ACK codebook for a SPS PDSCH reception (e.g., the pseudo code for generating a HARQ-ACK codebook for a SPS PDSCH reception defined in 3GPP).

For the semi-static HARQ-ACK codebook (e.g., 3GPP TS 38.213 Type-1 HARQ-ACK codebook), the size of the HARQ-ACK codebook and an order of HARQ-ACK bits may be determined according to a semi-statically parameter (e.g., a parameter configured by higher layer signaling). For a serving cell c, an active downlink BWP (bandwidth part) and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink SCS configuration and a downlink SCS configuration;
d) a semi-static uplink and downlink frame structure configuration;
c) a downlink slot offset parameter (e.g., 3GPP parameter N_{slot,offset,c}^{DL}) for the serving cell c and its corresponding slot offset SCS (e.g., 3GPP parameter μ_{offset,DL,c}), and a slot offset parameter (e.g., 3GPP parameter N_{slot,offset}^{UL}) for a primary serving cell and its corresponding slot offset SCS (e.g., 3GPP parameter μ_{offset,UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4; and for the third row of the time domain resource allocation table, the start OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

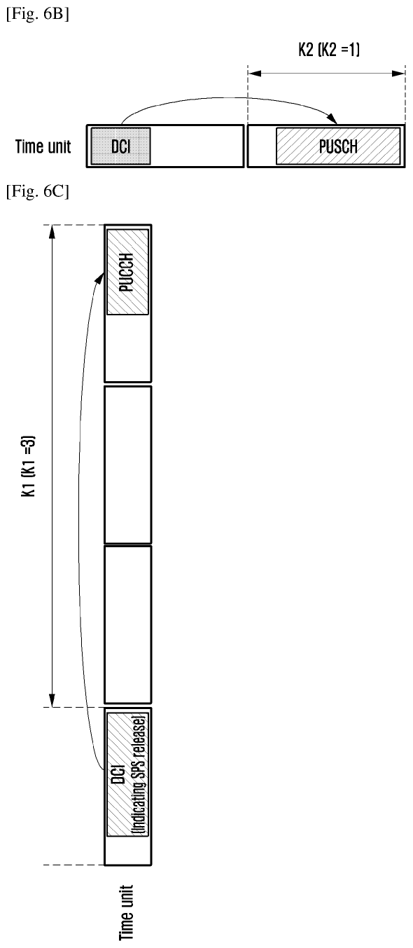

FIGS. 8A and 8B illustrate examples of a time domain resource allocation table. Specifically, FIG. 8A illustrates a time domain resource allocation table in which one PDSCH is scheduled by one row, and FIG. 8B illustrates a time domain resource allocation table in which multiple PDSCHs are scheduled by one row. Referring to FIG. 8A, each row corresponds to a value of a timing parameter K0, a value of S indicating a starting symbol, and a value of L indicating a length, where an SLIV may be determined by the value of S and the value of L. Referring to FIG. 8B, unlike FIG. 8A, each row corresponds to values of multiple sets of {K0, S, L}.

In some implementations, the dynamic HARQ-ACK codebook (e.g., 3GPP Type-2 HARQ-ACK codebook) and/or the enhanced dynamic HARQ-ACK codebook (e.g., 3GPP Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m} or V_{T-DAI}^{UL}. Numbers of bits of the C-DAI and T-DAI are limited.

For example, in case that the C-DAI or T-DAI is represented with 2 bits, the value of the C-DAI or T-DAI in the DCI may be determined by equations in Table 1. V_{T-DAI,m} of V_{T-DAI}^{UL} is the value of the T-DAI in DCI received in a PDCCH Monitoring, Occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| | V_{T-DAI, m} or | |
|---|---|---|
| MSB, LSB of | V_{C-DAI, c, m} or | |
| DAI Field | V_{T-DAI}^{UL} | Y |
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| | V_{T-DAI, m} or | |
|---|---|---|
| DAI field | V_{C-DAI, c, m} | Y |
| 0 | 1 | (Y − 1) mod 2 + 1 = 1 |
| 1 | 2 | (Y − 1) mod 2 + 1 = 2 |

In some implementations, whether to feed back (or report) HARQ-ACK information may be configured by higher layer parameters or dynamically indicated by DCI. The mode of feeding back (or reporting) the HARQ-ACK information (HARQ-ACK feedback mode or HARQ-ACK reporting mode) may be at least one of the following modes.
HARQ-ACK feedback mode 1 (which may be referred to as a first HARQ-ACK feedback mode in embodiments of the disclosure): transmitting ACK or NACK (ACK/NACK). For example, for a PDSCH reception, if the UE decodes a corresponding transport block correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.
HARQ-ACK feedback mode 2 (which may be referred to as a second HARQ-ACK feedback mode in embodiments of the disclosure): transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B).

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter, N_{PUCCH}^{repeat} related to the number of repetitions of PUCCH; When the parameter N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be performed one or more times.

It should be noted that, steps of methods of the disclosure may be implemented in any order.

It should be noted that, in methods of the disclosure, “canceling a transmission” may mean canceling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH carrying A may be understood as a PUCCH/PUSCH only carrying A, and may also be understood as a PUCCH/PUSCH carrying at least A.

It should be noted that “slot” may be replaced by “subslot” or “time unit” in embodiments of the disclosure.

It should be noted that “at least one” in embodiments of the disclosure may be understood as “one” or “multiple”. In the case of “multiple”, any permutation and combination may be used. For example, at least one of “A”, “B”, and “C” may be: “A”, “B”, “C”, “A-B”, “B-A”, “A-B-C”, “C-B-A”, “A-B-C-A”, “A-B-C-C-B”, and/or the like.

In some cases, a HARQ-ACK feedback mode for MBS may be the above-described HARQ-ACK feedback mode 2 (NACK-only). How to determine a PUCCH for carrying HARQ-ACK is a problem that needs to be solved.

In some implementations, it may be determined according to at least one of the following manners MN1 to MN2.

### Manner MN1

In some implementations, a specific (or predetermined) PUCCH resource table/list may be configured for the HARQ-ACK feedback mode 2 by higher layer signaling (for example, configured in a 3GPP parameter pucch-ConfigurationListMulticast2-r17). The specific PUCCH resource table may provide or indicate a correspondence or mapping relationship between a set of HARQ-ACK information and a set of PUCCH resource indexes. According to HARQ-ACK information, the UE determines a PUCCH resource index in the specific PUCCH resource table by looking up in the table, and the UE transmits a PUCCH resource corresponding to the index. For example, the UE may transmit the HARQ-ACK information in the PUCCH resource with the determined PUCCH resource index.

In some examples, in the PUCCH resource table, states of HARQ-ACK information and PUCCH resources may have a one-to-one correspondence. Table 3 shows an example of the specific PUCCH resource table that provides the correspondence or mapping relationship between PUCCH resource indexes and HARQ-ACK information. For example, as shown in Table 3, each state of HARQ-ACK information corresponds to a unique PUCCH resource index. As an example, when the HARQ-ACK information is 1-bit NACK, a PUCCH with an index of 0 in the specific PUCCH resource table is transmitted. As another example, when the HARQ-ACK information is 2-bit (ACK, NACK), a PUCCH with an index of 2 in the specific PUCCH resource table is transmitted. It should be noted that in a HARQ-ACK codebook, ‘I’ may be used to represent ACK, and ‘0’ to represent NACK.

In embodiments of the disclosure, a state of HARQ-ACK information includes a value (ACK or NACK) corresponding to each HARQ-ACK information bit in the HARQ-ACK information. For example, when a number of HARQ-ACK information bits is 1, the state of the HARQ-ACK information is NACK. For another example, when the number of the HARQ-ACK information bits is 2, the state of the HARQ-ACK information may include (NACK, NACK), (ACK, NACK) and (ACK, NACK). For the HARQ-ACK feedback mode 2, a value corresponding to at least one HARQ-ACK information bit in each state is NACK.

It should be noted that, the correspondence or mapping relationship between the PUCCH resource indexes and the HARQ-ACK information shown in table 3 is only an example, and any other suitable correspondence or mapping relationship may be adopted. For the purpose of differentiation, the PUCCH resource indexes in Table 3 may be referred to as actual PUCCH resource indexes.

TABLE 3

| PUCCH Resource | |
|---|---|
| Index | HARQ-ACK Information |
| 0 | NACK |
| 1 | NACK, NACK |
| 2 | ACK, NACK |
| 3 | NACK, ACK |
| 4 | NACK, NACK, NACK |
| 5 | ACK, NACK, NACK |
| 6 | NACK, ACK, NACK |
| 7 | NACK, NACK, ACK |
| 8 | ACK, ACK, NACK |
| 9 | ACK, NACK, ACK |
| 10 | NACK, ACK, ACK |
| 11 | NACK, NACK, NACK, NACK |
| 12 | ACK, NACK, NACK, NACK |
| 13 | NACK, ACK, NACK, NACK |
| 14 | NACK, NACK, ACK, NACK |
| 15 | ACK, ACK, NACK, NACK |
| 16 | ACK, NACK, ACK, NACK |
| 17 | NACK, ACK, ACK, NACK |
| 18 | NACK, NACK, NACK, ACK |
| 19 | ACK, NACK, NACK, ACK |
| 20 | NACK, ACK, NACK, ACK |
| 21 | NACK, NACK, ACK, ACK |
| 22 | ACK, ACK, NACK, ACK |
| 23 | ACK, NACK, ACK, ACK |
| 24 | NACK, ACK, ACK, ACK |
| 25 | ACK, ACK, ACK, NACK |

In some examples, the specific PUCCH resource table may provide a correspondence or mapping relationship between a set of HARQ-ACK information and a set of PUCCH resource indexes for different numbers of HARQ-ACK information bits. Table 4 shows an example of the specific PUCCH resource table that provides the correspondence or mapping relationship between the set of HARQ-ACK information and the set of PUCCH resource indexes for different numbers of HARQ-ACK information bits. For example, as shown in Table 4, the specific PUCCH resource table may contain four subsets for different numbers of HARQ-ACK bits, and the numbers of HARQ-ACK bits corresponding to the four subsets are 1, 2, 3 and 4, respectively. The PUCCH resource indexes are for indexes of a corresponding subset. The indexes for the corresponding subset may be converted into the actual PUCCH resource indexes of the PUCCH resources in the specific PUCCH resource table, for example, the indexes as shown in Table 3. As an example, when the HARQ-ACK information is 2-bit (ACK, NACK), an index corresponding to the HARQ-ACK information in Table 4 is 1, and the index is converted into the actual PUCCH resource index of 2 in Table 3. Therefore, a PUCCH with the PUCCH resource index of 2 is transmitted. As another example, when the HARQ-ACK information is 3-bit (ACK, NACK, NACK), a PUCCH with a PUCCH resource index of 5 is transmitted.

For the purpose of differentiation, the PUCCH resource indexes in Table 4 may be referred to as reference PUCCH resource indexes. According to the PUCCH resource indexes, the corresponding actual PUCCH resource indexes may be determined.

TABLE 4

| PUCCH | | | | |
|---|---|---|---|---|
| Resource | HARQ-ACK Information | | | |
| Index | 1-bit | 2-bit | 3-bit | 4-bit |
| 0 | NACK | NACK, NACK | NACK, NACK, NACK | NACK, NACK, NACK, NACK |
| 1 | | ACK, NACK | ACK, NACK, NACK | ACK, NACK, NACK, NACK |
| 2 | | NACK, ACK | NACK, ACK, NACK | NACK, ACK, NACK, NACK |
| 3 | | | NACK, NACK, ACK | NACK, NACK, ACK, NACK |
| 4 | | | ACK, ACK, NACK | ACK, ACK, NACK, NACK |
| 5 | | | ACK, NACK, ACK | ACK, NACK, ACK, NACK |
| 6 | | | NACK, ACK, ACK | NACK, ACK, ACK, NACK |
| 7 | | | | NACK, NACK, NACK, ACK |
| 8 | | | | ACK, NACK, NACK, ACK |
| 9 | | | | NACK, ACK, NACK, ACK |
| 10 | | | | NACK, NACK, ACK, ACK |
| 11 | | | | ACK, ACK, NACK, ACK |
| 12 | | | | ACK, NACK, ACK, ACK |
| 13 | | | | NACK, ACK, ACK, ACK |
| 14 | | | | ACK, ACK, ACK, NACK |

It should be noted that, the PUCCH may be determined in the same way for HARQ-ACK only in response to SPS PDSCHs and HARQ-ACK in response to PDSCHs including a dynamically scheduled PDSCH (PDSCH reception with a corresponding PDCCH).

The method is simple to implement, and thus can reduce the implementation complexity of the UE and the base station.

### Manner MN2

In some implementations, a specific (or predetermined) PUCCH resource table may be configured for the HARQ-ACK feedback mode 2 by higher layer signaling (for example, configured in a 3GPP parameter pucch-ConfigurationListMulticast2-r17). The specific PUCCH resource table may provide or indicate a correspondence or mapping relationship between a set of HARQ-ACK information and a set of PUCCH resource indexes. According to HARQ-ACK information, the UE may determine a PUCCH resource index in the specific PUCCH resource table by looking up in the table, and the UE transmits a PUCCH resource corresponding to the PUCCH resource index. For example, the UE may transmit the HARQ-ACK information in the PUCCH resource with the determined PUCCH resource index.

In some examples, a state of one HARQ-ACK information may correspond to more than one PUCCH resource. Table 5 shows an example of the specific PUCCH resource table that provides a correspondence or mapping relationship between PUCCH resource indexes and HARQ-ACK information. For example, as shown in Table 5, 1-bit NACK information may correspond to 4 PUCCH resources, and each state of 2-bit HARQ-ACK information may correspond to 2 PUCCH resources. If a state of one HARQ-ACK information corresponds to more than one PUCCH resource, for HARQ-ACK information indicated by DCI (for example, the HARQ-ACK information in response to a PDSCH scheduled by a DCI format or a DCI format indicating SPS PDSCH release), one of the multiple resources may be indicated by a PRI (PUCCH resource indicator) in the last DCI format. In a specific example, when the HARQ-ACK information is (NACK, NACK), corresponding PUCCH resource indexes are 4 and 5, and when the PRI indicates 0, the UE transmits a PUCCH with an index of 4 in the specific PUCCH resource table; and when the PRI indicates 1, the UE transmits a PUCCH with an index of 5 in the specific PUCCH resource table.

In some implementations, the same specific PUCCH resource table configured may be used for HARQ-ACK only in response to SPS PDSCHs and HARQ-ACK in response to PDSCHs that includes a dynamically scheduled PDSCH. For the HARQ-ACK only in response to the SPS PDSCHs, if one HARQ-ACK state corresponds to more than one PUCCH resource, the UE may be specified by protocols and/or configured by higher layer signaling to transmit a PUCCH with a smallest index (or largest index) in the more than one PUCCH resource.

TABLE 5

| PUCCH Resource | |
|---|---|
| Index | HARQ-ACK Information |
| 0 | NACK |
| 1 | NACK |
| 2 | NACK |
| 3 | NACK |
| 4 | NACK, NACK |
| 5 | NACK, NACK |
| 6 | ACK, NACK |
| 7 | ACK, NACK |
| 8 | NACK, ACK |
| 9 | NACK, ACK |
| 10 | NACK, NACK, NACK |
| 11 | ACK, NACK, NACK |
| 12 | NACK, ACK, NACK |
| 13 | NACK, NACK, ACK |
| 14 | ACK, ACK, NACK |
| 15 | ACK, NACK, ACK |
| 16 | NACK, ACK, ACK |
| 17 | NACK, NACK, NACK, NACK |
| 18 | ACK, NACK, NACK, NACK |
| 19 | NACK, ACK, NACK, NACK |
| 20 | NACK, NACK, ACK, NACK |
| 21 | ACK, ACK, NACK, NACK |
| 22 | ACK, NACK, ACK, NACK |
| 23 | NACK, ACK, ACK, NACK |
| 24 | NACK, NACK, NACK, ACK |
| 25 | ACK, NACK, NACK, ACK |
| 26 | NACK, ACK, NACK, ACK |
| 27 | NACK, NACK, ACK, ACK |
| 28 | ACK, ACK, NACK, ACK |
| 29 | ACK, NACK, ACK, ACK |
| 30 | NACK, ACK, ACK, ACK |
| 31 | ACK, ACK, ACK, NACK |

In some implementations, the specific PUCCH resource table may be configured for HARQ-ACK only in response to SPS PDSCHs and HARQ-ACK in response to PDSCHs that include a dynamically scheduled PDSCH (for example, may be configured in a 3GPP parameter pucch-ConfigurationListMulticast2-r17). For example, in the specific PUCCH resource table corresponding to the HARQ-ACK only in response to the SPS PDSCHs, states of HARQ-ACK information and PUCCH resources may have a one-to-one correspondence.

Compared with manner MN1, the method can improve the scheduling flexibility by indicating the PUCCH resources through the PRI.

It should be noted that, the correspondence or mapping relationship between the states of HARQ-ACK and the PUCCH resource indexes in Table 3, Table 4 or Table 5 is only an example, and the embodiments of the disclosure are not limited thereto, and other correspondences or mapping methods may be adopted.

In some cases, a HARQ-ACK feedback mode for MBS may be the above-described HARQ-ACK feedback mode 2 (NACK-only). For example, a feedback mode of HARQ-ACK for a PDSCH associated with a G-RNTI or a G-CS-RNTI may be the above-described HARQ-ACK feedback mode 2. If a PUCCH carrying HARQ-ACK information of NACK-only (e.g., HARQ-ACK information to be provided according to the HARQ-ACK feedback mode 2) overlaps with a PUCCH carrying other UCI(s) or a PUSCH in time domain, the HARQ-ACK information of NACK-only (e.g., HARQ-ACK information to be provided according to the HARQ-ACK feedback mode 2) is converted into HARQ-ACK information for the HARQ-ACK feedback mode 1 (in which ACK or NACK (ACK/NACK) is transmitted) (for example, the HARQ-ACK information is provided according to the HARQ-ACK feedback mode 1) and multiplexed with the other UCI(s) or uplink data. For example, the HARQ-ACK information and the other UCI(s) or uplink data may be multiplexed in a PUCCH or PUSCH. In order to reduce blind detection by a base station, a result of the multiplexing should not depend on HARQ-ACK information (decoding of a PDSCH); for example, it is assumed that the PUCCH carrying the HARQ-ACK information of NACK-only always exists, the UE may select different PUCCH resources due to different HARQ-ACK information states, and time domain positions of the PUCCH resources will affect the result of the multiplexing. How to ensure the consistency of understanding of the multiplexing result between the UE and the base station is a problem that needs to be solved.

In some implementations, a HARQ-ACK feedback mode may be the HARQ-ACK feedback mode 2 (NACK-only), and a specific (or predetermined) PUCCH resource table may be configured for the HARQ-ACK feedback mode 2 by higher layer signaling (for example, configured in a 3GPP parameter pucchConfigurationListMulticast2-r17). At least one of the following manners MN3 to MN10 may be adopted.

### Manner MN3

In some implementations, it may be specified by protocols that time domain resources of multiple PUCCH resources corresponding to the same HARQ-ACK bit in the specific PUCCH resource table are the same (for example, OFDM symbols of the PUCCH resources are the same).

The method is simple to implement, can thus reduce the implementation complexity of the UE and the base station. Also, the method ensures the consistency of understanding of the UCI multiplexing between the UE and the base station consistent, thereby improving the reliability of the uplink transmission.

### Manner MN4

In some implementations, it may be specified by protocols that time domain resources of all PUCCH resources in the specific PUCCH resource table are the same (for example, OFDM symbols of the PUCCH resources are the same).

The method is simple to implement, and thus can reduce the implementation complexity of the UE and the base station. Also, the method ensures the consistency of understanding of the UCI multiplexing between the UE and the base station, thereby improving the reliability of the uplink transmission. Compared with manner MN3, the method can ensure the consistency of understanding of the time domain positions of the PUCCH resources between the UE and the base station when missing detection of the DCI occurs, thereby improving the reliability of the PUCCH multiplexing in the case of missing detection.

### Manner MN5

In some implementations, it may be specified by protocols and/or configured by higher layer signaling that, a PUCCH among multiple PUCCH resources corresponding to the same HARQ-ACK bit in the specific PUCCH resource table (for example, a PUCCH with a smallest (or largest) index; for another example, a PUCCH for which HARQ-ACK information is all NACKs) is a reference PUCCH determined to be multiplexed with other PUCCHs or PUSCHs. The UE performs multiplexing with other PUCCHs or PUSCHs according to time domain resources of the reference PUCCH. For example, if the reference PUCCH overlaps with a PUSCH in time domain, the HARQ-ACK information is multiplexed in the PUSCH.

The method is simple to implement, and thus can reduce the implementation complexity of the UE and the base station. Also, the method ensures the consistency of understanding of the UCI multiplexing between the UE and the base station, thereby improving the reliability of the uplink transmission.

### Manner MN6

In some implementations, it may be specified by protocols and/or configured by higher layer signaling that, a PUCCH in all PUCCH resources in the specific PUCCH resource table (for example, a PUCCH with a smallest (or largest) index; for another example, a PUCCH for which HARQ-ACK information is all NACKs) is a reference PUCCH determined to be multiplexed with other PUCCHs or PUSCHs. The UE performs multiplexing with other PUCCHs or PUSCHs according to time domain resources of the reference PUCCH.

The method is simple to implement, and thus can reduce the implementation complexity of the UE and the base station. Also, the method ensures the consistency of understanding of the UCI multiplexing between the UE and the base station, thereby improving the reliability of the uplink transmission. Compared with manner MN5, the method can ensure the consistency of understanding of the time domain positions of the PUCCH resources between the UE and the base station when missing detection of the DCI occurs, thus improving the reliability of the PUCCH multiplexing in the case of missing detection.

### Manner MN7

In some implementations, it may be specified by protocols and/or configured by higher layer signaling that, a reference PUCCH resource is all symbols included in a PUCCH slot/subslot, and the UE performs multiplexing with other PUCCHs or PUSCHs according to time domain resources of the reference PUCCH.

The method is simple to implement, and thus can reduce the implementation complexity of the UE and the base station. Also, the method ensures the consistency of understanding of the UCI multiplexing between the UE and the base station, thereby improving the reliability of the uplink transmission.

### Manner MN8

In some implementations, it may be specified by protocols and/or configured by higher layer signaling that, a PUCCH with an earliest (or latest) starting symbol among multiple PUCCH resources corresponding to the same HARQ-ACK bit in the specific PUCCH resource table is a reference PUCCH determined to be multiplexed with other PUCCHs or PUSCHs. The UE performs multiplexing with other PUCCHs or PUSCHs according to time domain resources of the reference PUCCH. For example, if the reference PUCCH overlaps with a PUSCH in time domain, the HARQ-ACK information is multiplexed in the PUSCH.

The method is simple to implement, and thus can reduce the implementation complexity of the UE and the base station. Also, the method ensures the consistency of understanding of the UCI multiplexing between the UE and the base station, thereby improving the reliability of the uplink transmission.

### Manner MN9

In some implementations, it may be specified by protocols and/or configured by higher layer signaling that, a PUCCH with an earliest (or latest) starting symbol among all PUCCH resources in the specific PUCCH resource table is a reference PUCCH determined to be multiplexed with other PUCCHs or PUSCHs. The UE performs multiplexing with other PUCCHs or PUSCHs according to time domain resources of the reference PUCCH.

The method is simple to implement, and thus can reduce the implementation complexity of the UE and the base station. Also, the method ensues the consistency of understanding of the UCI multiplexing between the UE and the base station, thereby improving the reliability of the uplink transmission. Compared with manner MN5, the method can ensure the consistency of understanding of the time domain positions of the PUCCH resources between the UE and the base station when missing detection of the DCI occurs, thus improving the reliability of the PUCCH multiplexing in the case of missing detection.

It should be noted that, if there are multiple reference PUCCHs determined in manner MN8 or MN9, one of the multiple reference PUCCHs may be determined as a final reference PUCCH according to manner MN4 or MN5.

### Manner MN10

In some implementations, it may be specified by protocols and/or configured by higher layer signaling that, a union of time domain resources of all of multiple PUCCH resources corresponding to the same HARQ-ACK bit in the specific PUCCH resource table is a time domain resource of a reference PUCCH determined to be multiplexed with other PUCCHs or PUSCHs. Alternatively, a union of time domain resources of all PUCCH resources in the specific PUCCH resource table is the time domain resource of the reference PUCCH determined to be multiplexed with other PUCCHs or PUSCHs. The UE performs multiplexing with other PUCCHs or PUSCHs according to time domain resources of the reference PUCCH. For example, if the reference PUCCH overlaps with a PUSCH in time domain, the HARQ-ACK information is multiplexed in the PUSCH.

The method is simple to implement, and thus can reduce the implementation complexity of the UE and the base station. Also, the method ensures the consistency of understanding of the UCI multiplexing between the UE and the base station, thereby improving the reliability of the uplink transmission.

In some cases, a HARQ-ACK feedback mode for MBS may be the HARQ-ACK feedback mode 2 (NACK-only). For example, a feedback mode of HARQ-ACK for a PDSCH associated with a G-RNTI or a G-CS-RNTI may be the HARQ-ACK feedback mode 2. The UE may cancel the transmission of a PUCCH or PUSCH with a lower priority if a PUCCH carrying HARQ-ACK information of NACK-only with a higher priority overlaps with the PUCCH or PUSCH with the lower priority in time domain. For example, the UE cancels the transmission of the PUCCH and/or PUSCH with the lower priority before the first symbol that overlaps with the PUCCH with the higher priority.

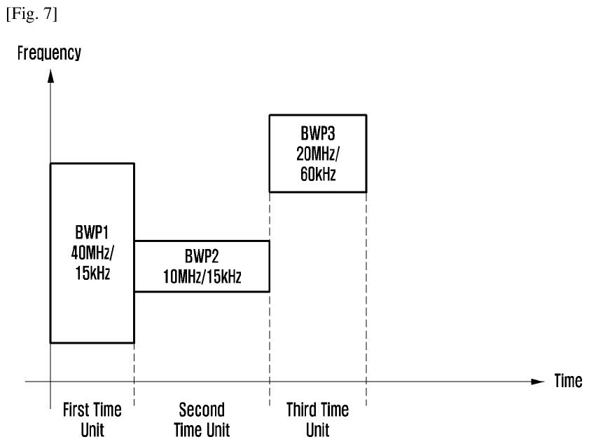

For example, as shown in FIG. 9, DCI schedules a PUCCH with the higher priority overlapping with a PUCCH with the lower priority in time domain, and the UE shall cancel the transmission of the PUCCH with the lower priority before the first symbol (symbol 5) that overlaps with the PUCCH with the higher priority. The DCI scheduling the PUCCH with the higher priority and the PUCCH with the higher priority may be required to satisfy a predefined timing relationship, for example, that a time interval between an end position of a PDCCH carrying the DCI and a starting position of the PUCCH with the higher priority is not less than a predefined time T. For example, T may be T_{proc,2} defined in 3GPP TS 38.213.

With respect to HARQ-ACK feedback of NACK-only, since the base station may not know a starting position of a PUCCH resource carrying the HARQ-ACK, how to determine the starting symbol (position) of the PUCCH resource carrying the HARQ-ACK is a problem that needs to be solved.

In some implementations, a HARQ-ACK feedback mode may be the HARQ-ACK feedback mode 2 (NACK-only), and a specific PUCCH resource table may be configured for the HARQ-ACK feedback mode 2 by higher layer signaling (for example, may be configured in a 3GPP parameter pucch-ConfigurationListMulticast2-r17). A PUCCH or PUSCH with the lower priority may be cancelled based on a starting symbol of the reference PUCCH determined by manners MN5 to MN10 as the first symbol with the higher priority. The HARQ-ACK is indicated by a DCI format, and a PDCCH carrying the DCI format and the starting symbol of the determined reference PUCCH may be required to satisfy a predefined timing relationship, for example, that a time interval between an end position of the PDCCH carrying the DCI and a starting position (e.g., starting symbol) of the determined reference PUCCH is not less than a predefined time. As an example, the reference PUCCH may be determined according to one or more of manners MN5 to MN10, and the UE may cancel the transmission of the PUCCH and/or PUSCH with the lower priority before the starting symbol of the determined reference PUCCH (which is the first symbol that overlaps with the PUCCH with the higher priority).

The method clarifies the method for the PUCCH carrying the HARQ-ACK information of NACK-only with the higher priority to cancel the PUCCH or PUSCH with the lower priority, which can improve the reliability of the uplink transmission.

It should be noted that, the method of determining the reference PUCCH according to one or more of manners MN5 to MN10 is also applicable to determining the reference PUCCH when the HARQ-ACK is all ACKs. According to the reference PUCCH, the UE multiplexes or prioritizes a PUCCH and/or PUSCH overlapping with the reference PUCCH in time domain, and determines a timing relationship that the multiplexing or prioritization needs to satisfy.

In some implementations, the canceled PUCCH or PUSCH with the lower priority may be determined according to the actually transmitted PUCCH with the higher priority. For the HARQ-ACK feedback mode 2, the UE is required to determine the actual PUCCH according to a result of decoding of a PDSCH, and the timing condition for the prioritization may be that a time interval between an end position (symbol) of the PDSCH and a starting position of the PUCCH with the higher priority is not less than a predefined time T′. This can ensure that the UE has enough time to cancel the PUCCH or PUSCH with the lower priority, which can improve the reliability of the PUCCH with the higher priority.

In some cases, the SPS PDSCH may be configured with a transmission with repctitions. For example, a parameter indicating the transmission of the SPS PDSCH with repetitions (e.g., 3GPP parameter pdsch-AggregationFactor) may be configured in a SPS PDSCH configuration (e.g., 3GPP IE SPS-Config). For a dynamically scheduled unicast PDSCH, if it is scheduled by a DCI format (e.g., DCI format 1_1), a number of repetitions of the PDSCH transmission scheduled by the DCI format may be determined according to a parameter for the transmission with repetitions (e.g., 3GPP parameter pdsch-AggregationFactor) configured in a PDSCH configuration (e.g., 3GPP IE PDSCH-Config). When a DCI format (e.g., DCI format 1_1) schedules retransmission of a SPS PDSCH, a number of repetitions of the retransmission of the SPS PDSCH may be determined according to the parameter for the transmission with repetitions configured in the PDSCH configuration. Unlike the unicast PDSCH, a parameter for a multicast PDSCH transmission with repetitions is configured for different G-RNTIs separately. For a multicast SPS PDSCH, how to determine a number of repetitions when the multicast SPS PDSCH is retransmitted is a problem that needs to be solved.

In some implementations, the UE receives a DCI format scrambled by a G-CS-RNTI (e.g., DCI format 4_1 and/or DCI format 4_2) (for example, a new data indicator (NDI) field in the DCI indicates 1) that schedules a retransmission of a SPS PDSCH, and a number of repetitions of the retransmission of the SPS PDSCH may be determined according to at least one of manners MN11˜MN13.

### Manner MN11

In some implementations, the number of repetitions of the retransmission of the SPS PDSCH may be a parameter indicating the transmission of the SPS PDSCH with repctitions (e.g., 3GPP parameter pdsch-AggregationFactor) configured in the SPS PDSCH configuration (e.g., 3GPP IE SPS-Config).

The method is simple to implement, and thus can improve the reliability of the SPS PDSCH transmission with repetitions.

### Manner MN12

In some implementations, the number of repetitions of the retransmission of the SPS PDSCH may be indicated by a specific parameter configured by higher layer signaling or specified by protocols as a default value. For example, the default value may be 1.

The method is simple to implement, and thus can improve the reliability of the SPS PDSCH transmission with repetitions.

### Manner MN13

In some implementations, if a parameter of the number of repetitions of the PDSCH transmission (e.g., 3GPP parameter repetitionNumber) is indicated in the DCI format scheduling the retransmission of the SPS PDSCH, the number of repetitions of the retransmission of the SPS PDSCH may be the number of repetitions of the PDSCH transmission indicated in the DCI format; and/or, if the parameter of the number of repetitions of the PDSCH transmission is not indicated in the DCI format scheduling the retransmission of the SPS PDSCH, the number of repetitions of the retransmission of the SPS PDSCH may be determined by manner MN11 or MN12.

The method is simple to implement, and thus can improve the reliability of the SPS PDSCH transmission with repetitions. Compared with manner MN11 and MN12, the method can improve the scheduling flexibility.

In some cases, the UE receives multiple SPS PDSCHs, and HARQ-ACK information for the SPS PDSCHs is multiplexed in a same PUCCH. The UE receives SPS PDSCHs from slot n_{D}−N_{PDSCH}^{repeat}+1 to slot n_{D} for SPS PDSCH configuration s on a serving cell c, where N_{PDSCH}^{repeat} repeat is a number of repetitions of SPS PDSCH transmission. PDSCH N_{PDSCH}^{repeat} may be determined according to at least one of manners MN14˜MN15.

### Manner MN14

If a SPS configuration parameter (e.g., parameter SPS-Config) is configured with a PDSCH aggregation factor parameter (e.g., parameter pdsch-AggregationFactor-16), N_{PDSCH}^{repeat} may be provided by the PDSCH aggregation factor parameter (e.g., parameter pdsch-AggregationFactor-16) in the SPS configuration parameter (e.g., parameter SPS-Config), or if the SPS configuration parameter (e.g., parameter SPS-Config) is not configured with the PDSCH aggregation factor parameter (e.g., parameter pdsch-AggregationFactor-16) and a PDSCH configuration parameter (e.g., parameter PDSCH-Config) is configured with the PDSCH aggregation factor parameter (e.g., parameter pdsch-AggregationFactor), N_{PDSCH}^{repeat} may be determined by the PDSCH aggregation factor parameter (e.g., parameter pdsch-AggregationFactor-16) in the PDSCH configuration parameter (e.g., parameter PDSCH-Config), otherwise (if the SPS configuration parameter (e.g., parameter SPS-Config) is not configured with the PDSCH aggregation factor parameter (e.g., parameter pdsch-AggregationFactor-16) and the PDSCH configuration parameter (e.g., parameter PDSCH-Config) is not configured with the PDSCH aggregation factor parameter (e.g., parameter pdsch-AggregationFactor)), N_{PDSCH}^{repeat} is equal to 1.

The method can clarify which SPS PDSCH receptions the UE feeds back HARQ-ACK for, in case that unicast and multicast SPS PDSCHs are configured, which can improve the transmission reliability.

The method can clarify which time slots the UE feeds back HARQ-ACK for SPS PDSCH receptions, which can improve the transmission reliability.

### Manner MN15

For a unicast SPS PDSCH, if a SPS configuration parameter (e.g., parameter SPS-Config) is configured with a PDSCH aggregation factor parameter (e.g., parameter pdsch-AggregationFactor-16), N_{PDSCH}^{repeat} may be determined by the PDSCH aggregation factor parameter (e.g., parameter pdsch-AggregationFactor-16) in the SPS configuration parameter (e.g., parameter SPS-Config), or if the SPS configuration parameter (e.g., parameter SPS-Config) is not configured with the PDSCH aggregation factor parameter (e.g., parameter pdsch-AggregationFactor-16) and a PDSCH configuration parameter (e.g., parameter PDSCH-Config) is configured with the PDSCH aggregation factor parameter (e.g., parameter pdsch-AggregationFactor), N_{PDSCH}^{repeat} may be determined by the PDSCH aggregation factor parameter (e.g., parameter pdsch-AggregationFactor-16) in the PDSCH configuration parameter (e.g., parameter PDSCH-Config), otherwise (if the SPS configuration parameter (e.g., parameter SPS-Config) is not configured with the PDSCH aggregation factor parameter (e.g., parameter pdsch-AggregationFactor-16) and the PDSCH configuration parameter (e.g., parameter PDSCH-Config) is not configured with the PDSCH aggregation factor parameter (e.g., parameter pdsch-AggregationFactor)), N_{PDSCH}^{repeat} is equal to 1.

For a multicast SPS PDSCH, if a SPS configuration parameter (e.g., parameter SPS-Config) is configured with a PDSCH aggregation factor parameter (e.g., parameter pdsch-AggregationFactor-16), N_{PDSCH}^{repeat} be determined by the PDSCH aggregation factor parameter (e.g., parameter pdsch-AggregationFactor-16) in the SPS configuration parameter (e.g., parameter SPS-Config), otherwise (if the SPS configuration parameter (e.g., parameter SPS-Config) is not configured with the PDSCH aggregation factor parameter (e.g., parameter pdsch-AggregationFactor-16)), N_{PDSCH}^{repeat} is equal to 1.

The method can clarify which time slots the UE feeds back HARQ-ACK for SPS PDSCH receptions, in case that unicast and multicast SPS PDSCHs are configured, which can improve the transmission reliability.

For example, a HARQ-ACK codebook may be generated according to [pseudo code-1].

[Pseudo code-1]

```
Set N_{cells}^{DL} to the number of serving cells configured to the UE
Set N_{c}^{SPS} to the number of SPS PDSCH configurations configured to the UE for serving
cell c
Set N_{c}^{DL} to the number of DL slots on serving cell c with HARQ-ACK information for
SPS PDSCHs of the DL slots multiplexed on the PUCCH
Set j = 0 − HARQ-ACK information bit index
Set c = 0 − serving cell index
while c < N_{cells}^{DL}
    Set s = 0 − SPS PDSCH configuration index
  while s < N_{c}^{SPS}
      Set n_{D} = 0 − slot index
    while n_{D} < N_{c}^{DL}
        if {
          a UE is configured to receive SPS PDSCHs from slot n_{D} − N_{PDSCH}^{repeat} + 1
          to slot n_{D} for SPS PDSCH configuration s on serving cell c, excluding
          SPS PDSCHs that are not required to be received in any slot, due to
          overlapping with other SPS PDSCHs, or based on a UE capability for a
          number of PDSCHs that can be received, or due to overlapping with a set
          of symbols indicated as uplink (e.g., OFDM symbols) in a semi-static
          frame structure configured by higher layer signaling (e.g., parameter tdd-
          UL-DL-ConfigurationCommon or parameter tdd-UL-DL-
          ConfigurationDedicated), where N_{PDSCH}^{repeat} may be determined by a higher
          layer signaling configuration parameter, and HARQ-ACK information for
          all SPS PDSCHs is associated with the PUCCH
          }
          õⱼ^{ACK} = HARQ-ACK information bit for this SPS PDSCH reception
          j = j + 1;
        end if
        n_{D} = n_{D} + 1;
    end while
    s = s + 1;
  end while
  c = c + 1;
end while
```

FIG. 10 illustrates a flowchart of a method 1000 performed by a terminal according to some embodiments of the disclosure.

Referring to FIG. 10, in operation S1010, time domain overlapping among a first physical uplink control channel (PUCCH) associated with a second hybrid automatic repeat request-acknowledgement (HARQ-ACK) feedback mode and a second PUCCH or a physical uplink shared channel (PUSCH) is determined.

In operation S1020, the time domain overlapping among the first PUCCH and the second PUCCH and/or the PUSCH is resolved.

In some implementations, for example, HARQ-ACK information based on the second HARQ-ACK feedback mode (for example, as described above) is carried by the first PUCCH. The resolving of the time domain overlapping among the first physical uplink control channel (PUCCH) and the second PUCCH and/or the PUSCH includes: determining a reference PUCCH for the first PUCCH; and resolving the time domain overlapping among the first PUCCH and the second PUCCH and/or the PUSCH based on the determined reference PUCCH.

In some implementations, for example, the resolving of the time domain overlapping among the first PUCCH and the second PUCCH and/or the PUSCH based on the determined reference PUCCH includes: multiplexing the HARQ-ACK information with the second PUCCH and/or the PUSCH based on the determined reference PUCCH.

In some implementations, for example, the multiplexing of the HARQ-ACK information with the second PUCCH and/or the PUSCH based on the determined reference PUCCH includes: converting the HARQ-ACK information into HARQ-ACK information based on a first HARQ-ACK feedback mode (for example, as described above); and multiplexing the converted HARQ-ACK information with the second PUCCH and/or the PUSCH based on the determined reference PUCCH.

In some implementations, for example, the method 1000 further includes determining, based on the reference PUCCH, that a timing condition for multiplexing and/or prioritization among the first PUCCH and the second PUCCH and/or the PUSCH is satisfied.

In some implementations, for example, the first PUCCH is of a first priority, and the second PUCCH and/or the PUSCH is of a second priority lower than the first priority. The resolving of the time domain overlapping among the first PUCCH and the second PUCCH and/or the PUSCH includes: canceling transmission of the second PUCCH and/or the PUSCH before a starting position of the determined reference PUCCH.

In some implementations, for example, the determining of the reference PUCCH includes: receiving configuration information for the second HARQ-ACK feedback mode, where the configuration information indicates a correspondence between one or more HARQ-ACK information bit values and one or more PUCCH resources (e.g., the above-described specific (or predetermined) PUCCH resource table); and determining a PUCCH in the one or more PUCCH resources as the reference PUCCH.

In some implementations, for example, the determined reference PUCCH includes at least one of:
a PUCCH with a smallest PUCCH resource index in at least one PUCCH resource of the one or more PUCCH resources, the at least one PUCCH resource corresponding to the HARQ-ACK information carried by the first PUCCH;
a PUCCH with a largest PUCCH resource index in at least one PUCCH resource of the one or more PUCCH resources, the at least one PUCCH resource corresponding to the HARQ-ACK information carried by the first PUCCH;
a PUCCH of which all HARQ-ACK information bit values are negative acknowledgement (NACK) in at least one PUCCH resource of the one or more PUCCH resources, the at least one PUCCH resource corresponding to the HARQ-ACK information carried by the first PUCCH;
a PUCCH with a smallest PUCCH resource index in the one or more PUCCH resources;
a PUCCH with a largest PUCCH resource index in the one or more PUCCH resources;
a PUCCH of which all HARQ-ACK information bit values are NACK in the one or more PUCCH resources;
a PUCCH having all symbols included in a PUCCH time unit;
a PUCCH with an earliest starting symbol in at least one PUCCH resource of the one or more PUCCH resources, the at least one PUCCH resource corresponding to the HARQ-ACK information carried by the first PUCCH;
a PUCCH with a latest starting symbol in at least one PUCCH resource of the one or more PUCCH resources, the at least one PUCCH resource corresponding to the HARQ-ACK information carried by the first PUCCH;
a PUCCH with an earliest starting symbol in the one or more PUCCH resources;
a PUCCH with a latest starting symbol in the one or more PUCCH resources; or
a PUCCH for which time domain resources are a union of all PUCCH resources of at least one PUCCH resource of the one or more PUCCH resources, the at least one PUCCH resource corresponding to the HARQ-ACK information carried by the first PUCCH.

In some implementations, for example, the method 1000 further includes receiving configuration information for the second HARQ-ACK feedback mode, where the configuration information indicates a correspondence between one or more HARQ-ACK information bit values and one or more PUCCH resources. Time domain resources of all PUCCH resources corresponding to a number of same HARQ-ACK information bits of the one or more PUCCH resources are the same, and/or time domain resources of all the one or more PUCCH resources are the same.

In some implementations, for example, operations S1010 and/or S1020 and/or other additional operations may be performed based on various embodiments of the disclosure described above.

FIG. 11 illustrates a flowchart of a method performed by a terminal according to some embodiments of the disclosure.

Referring to FIG. 11, in operation S1110, first configuration information on a semi-persistent scheduling (SPS) physical downlink shared channel (PDSCH) (e.g., 3GPP IE SPS-Config) is received through higher layer signaling, wherein the first configuration information includes a parameter indicating a SPS PDSCH transmission with repetitions (e.g., 3gpp parameter pdsch-AggregationFactor).

Next, in operation S1120, downlink control information (DCI) is received through a downlink control channel (PDCCH), wherein the DCI is scrambled by a multicast radio network temporary identifier (RNTI) (e.g., G-CS-RNTI) and schedules a point-to-multipoint (PTM)-based retransmission of the SPS PDSCH.

In operation S1130, a number of repetitions of the PTM-based retransmission of the SPS PDSCH is determined.

In some implementations, for example, the determining of the number of repetitions of the PTM-based retransmission of the SPS PDSCH includes: determining the number of repetitions of the PTM-based retransmission of the SPS PDSCH based on the parameter indicating the transmission of the SPS PDSCH with repetitions included in the first configuration information.

In some implementations, for example, the determining of the number of repetitions of the PTM-based retransmission of the SPS PDSCH includes: receiving second configuration information on the number of repetitions of the PTM-based retransmission of the SPS PDSCH through the higher layer signaling; and determining the number of repetitions of the PTM-based retransmission of the SPS PDSCH based on the second configuration information.

In some implementations, for example, the determining of the number of repetitions of the PTM-based retransmission of the SPS PDSCH includes: in case that the DCI includes information indicating a number of repetitions of a PDSCH transmission, determining that the number of repetitions of the PTM-based retransmission of the SPS PDSCH as the number of repetitions of the PDSCH transmission indicated by the information included in the DCI; and/or in case that the DCI does not include the information indicating the number of repetitions of the PDSCH transmission, determining the number of repetitions of the PTM-based retransmission of the SPS PDSCH based on the first configuration information and/or the second configuration information.

In some implementations, for example, operations S1110 and/or S1120 and/or other additional operations may be performed based on various embodiments of the disclosure described above.

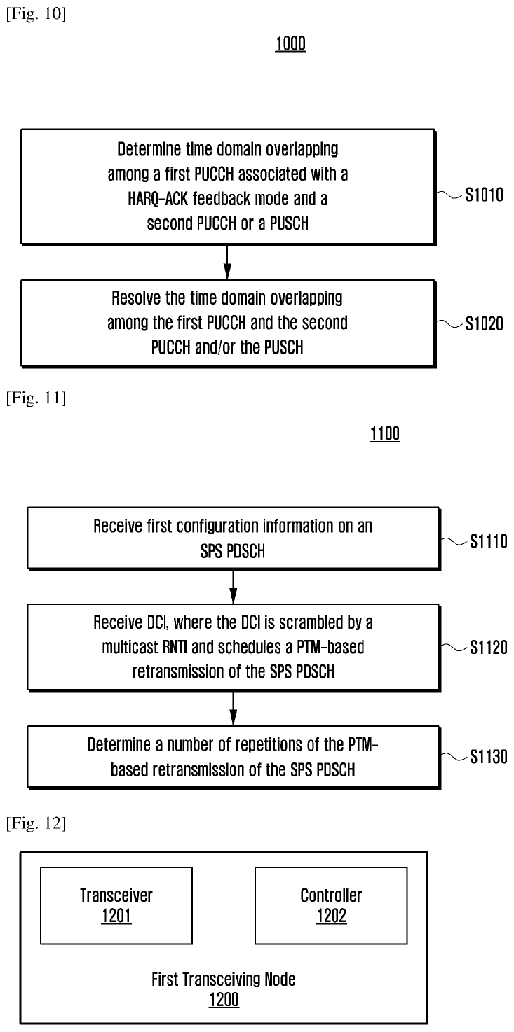

FIG. 12 illustrates a block diagram of a first transceiving node 1200 according to some embodiments of the disclosure.

Referring to FIG. 12, the first transceiving node 1200 may include a transceiver 1201 and a controller 1202.

The transceiver 1201 may be configured to transmit first data and/or first control signaling to a second transceiving node and receive second data and/or second control signaling from the second transceiving node in a time unit.

The controller 1202 may be an application specific integrated circuit or at least one processor. The controller 1202 may be configured to control the overall operation of the first transceiving node, including controlling the transceiver 1201 to transmit the first data and/or the first control signaling to the second transceiving node and receive the second data and/or the second control signaling from the second transceiving node in a time unit.

In some implementations, the controller 1202 may be configured to perform one or more of operations in the methods of various embodiments described above.

In the following description, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

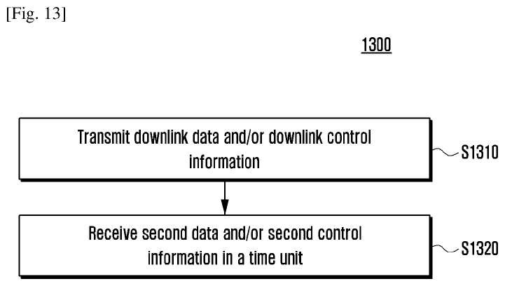

FIG. 13 illustrates a flowchart of a method 1300 performed by a base station according to some embodiments of the disclosure.

Referring to FIG. 13, in step S1310, the base station transmits downlink data and/or downlink control information.

In step S1320, the base station receives second data and/or second control information from a UE in a time unit.

For example, the method 1300 may include one or more of the operations performed by the base station described in various embodiments of the disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1-15. (canceled)

16. A method performed by a user equipment (UE) in a wireless communication system, the method comprising:
receiving, from a base station, configuration information indicating a second hybrid automatic repeat acknowledgement (HARQ-ACK) reporting mode, wherein the second HARQ-ACK reporting mode is associated with negative acknowledgement (NACK)-only feedback for multicast;
determining time domain overlapping among a first physical uplink control channel (PUCCH) associated with the second HARQ-ACK reporting mode and a second PUCCH or a physical uplink shared channel (PUSCH);
in case that the first PUCCH is overlapped with the second PUCCH or the PUSCH, multiplexing HARQ-ACK information for the first PUCCH with the second PUCCH or the PUSCH; and
transmitting, to the base station, the multiplexed HARQ-ACK information.

17. The method of claim 16, wherein a PUCCH resource table for the first PUCCH is configured for a semi persistent scheduling (SPS) physical downlink shared channel (PDSCH).

18. The method of claim 17, wherein states of HARQ-ACK information and PUCCH resources in the PUCCH resource table have a one-one correspondence.

19. The method of claim 16, wherein all values of the HARQ-ACK information for the first PUCCH are ACKs.

20. The method of claim 16, wherein multiplexing the HARQ-ACK information for the first PUCCH with the second PUCCH or the PUSCH comprises converting the HARQ-ACK information based on a first HARQ-ACK reporting mode, and
wherein the first HARQ-ACK reporting mode is for reporting an ACK value or a NACK value.

21. The method of claim 16, wherein all PUCCH resources associated with the second HARQ-ACK reporting mode have a same starting symbol and a same number of symbols.

22. A user equipment (UE) in a wireless communication system, the UE comprising:
a transceiver configured to transmit and receive signals; and
a controller coupled to the transceiver and configured to:
receive, from a base station, configuration information indicating a second hybrid automatic repeat acknowledgement (HARQ-ACK) reporting mode, wherein the second HARQ-ACK reporting mode is associated with negative acknowledgement (NACK)-only feedback for multicast,
determine time domain overlapping among a first physical uplink control channel (PUCCH) associated with the second HARQ-ACK reporting mode and a second PUCCH or a physical uplink shared channel (PUSCH),
in case that the first PUCCH is overlapped with the second PUCCH or the PUSCH, multiplex HARQ-ACK information for the first PUCCH with the second PUCCH or the PUSCH, and
transmit, to the base station, the multiplexed HARQ-ACK information.

23. The UE of claim 22, wherein a PUCCH resource table for the first PUCCH is configured for a semi persistent scheduling (SPS) physical downlink shared channel (PDSCH).

24. The UE of claim 23, wherein states of HARQ-ACK information and PUCCH resources in the PUCCH resource table have a one-one correspondence.

25. The UE of claim 22, wherein all values of the HARQ-ACK information for the first PUCCH are ACKs.

26. The UE of claim 22, wherein the controller is further configured to multiplex the HARQ-ACK information for the first PUCCH with the second PUCCH or the PUSCH by converting the HARQ-ACK information based on a first HARQ-ACK reporting mode, and
wherein the first HARQ-ACK reporting mode is for reporting an ACK value or a NACK value.

27. The UE of claim 22, wherein all PUCCH resources associated with the second HARQ-ACK reporting mode have a same starting symbol and a same number of symbols.
